(19) United States
(12) Patent Application Publication
(10) Pub. No.: US 2025/0278637 A1
(43) Pub. Date: Sep. 4, 2025

(54) USING A DEEP NEURAL MODEL TO GENERATE JOINT QUALITY SCORES FOR A CASING CONNECTION

(71) Applicant: Schlumberger Technology Corporation, Sugar Land, TX (US)

(72) Inventors: Soumil Shah, Lysaker (NO); Syed Aaquib Hussain, Abu Dhabi (UA); Arvind Sharma, Houston, TX (US); Alikhan Kurmankulov, Astana (KZ); Mohamed AlMahroos, Dhahran (SA)

(21) Appl. No.: 18/591,241

(22) Filed: Feb. 29, 2024

(51) Int. Cl. G06N 3/0985

(52) U.S. Cl. CPC G06N 3/0985

(57) ABSTRACT

A casing installation manager may obtain a training dataset including a plurality of torque-turns datasets for a plurality of casing joint connections. Each of the plurality of torque-turns datasets may include a joint quality score for an associated casing joint connection of the plurality of casing joint connections. A casing installation manager may train, using the training dataset, a deep learning model to generate a new joint quality score for a new torque-turns dataset.

### BACKGROUND OF THE DISCLOSURE

Casing is installed in a wellbore to perform various functions. For example, casing may be installed to protect the structural integrity of the wellbore, prevent ingress or egress of fluids through the wellbore, and so forth. Casing may include a steel pipe. Two or more casing segments may be connected together using a threaded connection. If the casing connection becomes cross-threaded, the casing connection may fail.

### SUMMARY

In some aspects, the techniques described herein relate to a method for classifying casing joint connections for casing in a wellbore. A casing installation manager obtains a training dataset including a plurality of torque-turns datasets for a plurality of casing joint connections. Each of the plurality of torque-turns datasets includes a joint quality score for an associated casing joint connection of the plurality of casing joint connections. The casing installation manager trains, using the training dataset, a deep learning model to generate a new joint quality score for a new torque-turns dataset.

In some aspects, the techniques described herein relate to a method for classifying casing joint connections for casing in a wellbore. A casing installation manager obtains a torque-turns dataset. The torque-turns dataset includes a plurality of rotation-series torque measurements for a casing joint connection. The casing installation manager receives, based on a pre-determined standard for the casing joint connection, a joint quality score. The casing installation manager scales the torque-turns dataset to a pre-determined scale based on the pre-determined standard. The casing installation manager trains, using the torque-turns dataset scaled to the pre-determined scale, a deep learning model to generate a new joint quality score for a new torque-turns dataset.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure may be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1-1 is a representation of a drilling system according to at least one embodiment of the present disclosure;

FIG. 1-2 is a representation of a joint connection of the casing of FIG. 1-1 between a first casing segment and a second casing segment.

FIG. 2-1 through FIG. 2-4 are representations of torque-turns datasets, according to at least one embodiment of the present disclosure.

FIG. 3 is a schematic representation of a casing connection management system, according to at least one embodiment of the present disclosure.

FIG. 4 is a representation of a casing connection management system, according to at least one embodiment of the present disclosure.

FIG. 5 is a representation of a deep learning model training system, according to at least one embodiment of the present disclosure.

FIG. 6 is a flowchart of a method for classifying joint connections, according to at least one embodiment of the present disclosure.

FIG. 7 is a flowchart of a method for classifying joint connections, according to at least one embodiment of the present disclosure.

FIG. 8 is a representation of a computing system, according to at least one embodiment of the present disclosure.

### DETAILED DESCRIPTION

This disclosure generally relates to devices, systems, and methods for utilizing a deep neural network to generate a joint quality score for a casing joint connection. Casing is installed in a wellbore for a variety of reasons, including to prevent ingress of fluids into the wellbore, prevent egress of fluids out of the wellbore, increase wellbore stability, any other reason, and combinations thereof. Typically, casing includes two or more steel casing sections (e.g., cylindrical steel pipes or tubes) connected with a threaded connection. The casing sections are inserted into the wellbore. Grout or cement may be pumped into the annulus between the casing and the wellbore wall. Once the grout is installed, removal, repair, replacement, or other actions on the casing sections is time-consuming and expensive and may carry risk of damage to the wellbore.

The casing connection may be categorized with a joint quality score. The joint quality score may be a representation of the quality of the connection between two casing connections. A high joint quality score may represent a joint connection that meets a specified sealing pressure and/or a specified structural strength. A poor casing connection may represent a joint connection that does not meet the specified sealing pressure and/or the specified structural strength. Thus, a poor casing connection may result in a casing failure. For example, the casing connection may not form a seal between the two casing sections. This may result in undesired fluid ingress or egress at the casing connection. In some embodiments, a poor casing connection may result in structural damage to the casing at the joint. Repair of the installed casing after casing joint connection may be time-consuming and expensive.

In some embodiments, two casing sections are connected with a threaded connection. To connect the sections, the casing sections are rotated relative to each other. This may result in an applied torque on the casing sections. In some situations, to determine the quality of the casing joint connection, an operator may analyze the torque with respect to rotational position while connecting the casing sections. The quality of the casing joint connection may be based on any torque-turns metric. For example, the quality of the casing joint connection may be based on whether the final torque is within a final torque range, or between a minimum torque and a maximum torque. In some examples, the quality of the casing joint connection may be based on whether the final number of turns is within a final rotation range, or between a minimum number of rotations (e.g., a minimum number of turns) and a maximum number of rotations (e.g., a maximum number of turns). In some examples, the quality of the casing joint connection may be based on a pattern of the change in torque with respect to the number of rotations.

Conventionally, identifying the casing connection quality may be performed by a skilled operator. For example, in situations where the final torque is within the final torque range and/or when the final number of rotations is within the final rotation range, the torque-turns patterns may be used to determine the casing connection quality. But the operator that identifies the torque-turns patterns may utilize his or her extensive experience, education, and training to identify a poor quality casing connection. Maintaining such a person on a drilling rig to examine each casing connection may not be practical. Indeed, operators often analyze the casing connection quality after a failure is identified. Thus, typical drilling systems are often reactive to poor casing connection quality.

In accordance with at least one embodiment of the present disclosure, a deep learning model may be trained to identify the casing connection quality based on the torque-turns information. For example, the deep learning model may be trained on the torque-turns patterns to identify poor casing connection quality. When the deep learning model identifies a poor casing connection quality, the casing installation manager may stop the installation of the casing segment. In this manner, the deep learning model may reduce or prevent the installation of casing segments having a poor joint connection. This may help to improve the casing quality, thereby reducing damage to the wellbore based on poor casing connections.

In some embodiments, to train the deep learning model, the operator may input previously measured torque-turns datasets. The torque-turns datasets may include a joint quality score identified by an operator. The joint quality scores may include a high joint quality (e.g., the joint meets or exceeds the pre-determined standards), a low joint quality (e.g., the joint is below the pre-determined standards), or an indeterminate joint quality (e.g., the joint quality is unable to be determined based on the torque-turns pattern). The deep learning model may analyze the training dataset of previously measured torque-turns datasets to learn to identify the joint quality score.

In accordance with at least one embodiment of the present disclosure, the operator may pre-process the torque-turns datasets to generate the training dataset. For example, a torque-turns data manager may scale the torque-turns datasets to a scale associated with the casing connection type. This may help the deep learning model to analyze the torque-turns datasets based on the same scale. In some examples, the torque-turns data manager may adjust image properties of a torque-turns graph to increase the number of torque-turns datasets used to train the deep learning model. This may provide the deep learning model with additional torque-turns datasets used in training, thereby improving the accuracy and/or relevance of the results of the deep learning model.

In some embodiments, the deep learning model is trained to over-identify casing connections having a poor connection quality. For example, the deep learning model may include a constraint to conservatively identify poor casing connections. Over-identifying poor connection quality may help to ensure that no casing connections installed with a poor quality. In this manner, the deep learning model may facilitate improved casing quality, thereby reducing damage to the wellbore based on poor casing connections.

As illustrated by the foregoing discussion, the present disclosure utilizes a variety of terms to describe features and advantages of the casing connection management system discussed herein. Additional detail is now provided regarding the meaning of such terms. For example, as used herein, the term “deep learning model” refers to a type of machine learning (ML) model including multiple layers of interconnected nodes. The layers may include visible layers, such as an input layer and an output layer, and hidden layers, which may perform analysis and computations based on the input data and data received from other nodes. The cross-layer interconnected nodes may process and transform input data. Each node in the layers may be configured to perform a specific task, such as communicate with other nodes, perform a computation, communicate with an output layer, and so forth. The number of nodes in the deep learning model may be a hyperparameter that is tuned to impact the model performance. As the deep neural model is trained, the weights of the various nodes may be adjusted based on a particular constraint or desired outcome. Examples of deep learning models include multi-layer perceptron (MLP), convolutional neural network (CNN), recurrent neural network (RNN), long short-term memory networks (LSTM), generative adversarial networks (GAN), autoencoders, transformers, any other neural network or deep neural model, and combinations thereof.

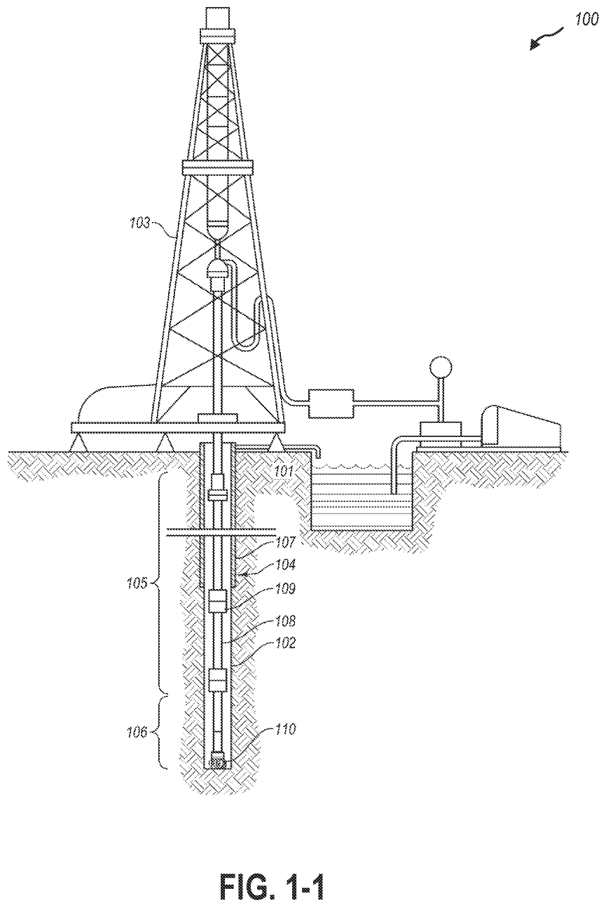

FIG. 1-1 shows one example of a drilling system 100 for drilling an earth formation 101 to form a wellbore 102. The drilling system 100 includes a drill rig 103 used to turn a drilling tool assembly 104 which extends downward into the wellbore 102. The drilling tool assembly 104 may include a drill string 105, a bottomhole assembly (“BHA”) 106, and a bit 110, attached to the downhole end of drill string 105.

The drill string 105 may include several joints of drill pipe 108 connected end-to-end through tool joints 109. The drill string 105 transmits drilling fluid through a central bore and transmits rotational power from the drill rig 103 to the BHA 106. In some embodiments, the drill string 105 may further include additional components such as subs, pup joints, etc. The drill pipe 108 provides a hydraulic passage through which drilling fluid is pumped from the surface. The drilling fluid discharges through selected-size nozzles, jets, or other orifices in the bit 110 for the purposes of cooling the bit 110 and cutting structures thereon, and for lifting cuttings out of the wellbore 102 as it is being drilled.

The BHA 106 may include the bit 110 or other components. An example BHA 106 may include additional or other components (e.g., coupled between to the drill string 105 and the bit 110). Examples of additional BHA components include drill collars, stabilizers, measurement-while-drilling (“MWD”) tools, logging-while-drilling (“LWD”) tools, downhole motors, underreamers, section mills, hydraulic disconnects, jars, vibration or dampening tools, other components, or combinations of the foregoing. The BHA 106 may further include a rotary steerable system (RSS). The RSS may include directional drilling tools that change a direction of the bit 110, and thereby the trajectory of the wellbore. At least a portion of the RSS may maintain a geostationary position relative to an absolute reference frame, such as gravity, magnetic north, and/or true north. Using measurements obtained with the geostationary position, the RSS may locate the bit 110, change the course of the bit 110, and direct the directional drilling tools on a projected trajectory.

In general, the drilling system 100 may include other drilling components and accessories, such as special valves (e.g., kelly cocks, blowout preventers, and safety valves). Additional components included in the drilling system 100 may be considered a part of the drilling tool assembly 104, the drill string 105, or a part of the BHA 106 depending on their locations in the drilling system 100.

The bit 110 in the BHA 106 may be any type of bit suitable for degrading downhole materials. For instance, the bit 110 may be a drill bit suitable for drilling the earth formation 101. Example types of drill bits used for drilling earth formations are fixed-cutter or drag bits. In other embodiments, the bit 110 may be a mill used for removing metal, composite, elastomer, other materials downhole, or combinations thereof. For instance, the bit 110 may be used with a whipstock to mill into casing 107 lining the wellbore 102. The bit 110 may also be a junk mill used to mill away tools, plugs, cement, other materials within the wellbore 102, or combinations thereof. Swarf or other cuttings formed by use of a mill may be lifted to surface or may be allowed to fall downhole.

As discussed herein, the casing 107 may be installed in the wellbore to protect the wellbore. For example, the casing 107 may help to prevent collapse of the wellbore from weak portions of the earth formation 101 (including soil, sand, eroded strata, jointed strata, and other weak portions of the earth formation 101). The casing 107 may further help to prevent the ingress of fluids into the wellbore 102 and/or the egress of fluids out of the wellbore 102 and into the surrounding earth formation 101.

During installation of the casing 107, a first casing segment may be at least partially inserted into the upper portion of the wellbore 102. A second casing segment may be suspended in the drill rig 103. A rotary element may rotate one of the casing segments relative to the other. For example, a top drive may rotate the upper casing segment in the drill rig 103 with respect to the lower segment. One or more torque sensors in the drill rig 103 may measure the applied torque to the casing segments. For example, the torque sensors may be located on the top drive and measure the torque the top drive applies to the upper casing segment. In some examples, the torque sensors may be located at any other location. A rotation sensor may sense the rotational position of the casing segments. For example, a rotation sensor on the top drive may detect the rotational position (including number of rotations and partial rotations) of the upper segment in the drill rig 103 as the top drive rotates the upper casing segment.

A casing connection management system may include a deep learning network trained to monitor the torque applied to the casing segments with respect to the rotational position. For example, the casing connection management system may collect a torque-turns dataset including torque measured with respect to rotational position (e.g., rotation-series torque measurements) and/or rotational position measured with respect to torque (e.g., torque-series rotation measurements). The deep learning network may be trained to identify the joint connection quality of the joint between the two casing segments. The deep learning network may generate a joint quality score for the joint connection. If the deep learning network identifies a poor quality joint quality score, the drilling system 100 may disconnect the casing segments and reconnect them. This may facilitate improved and more reliable installation of high quality joint connections.

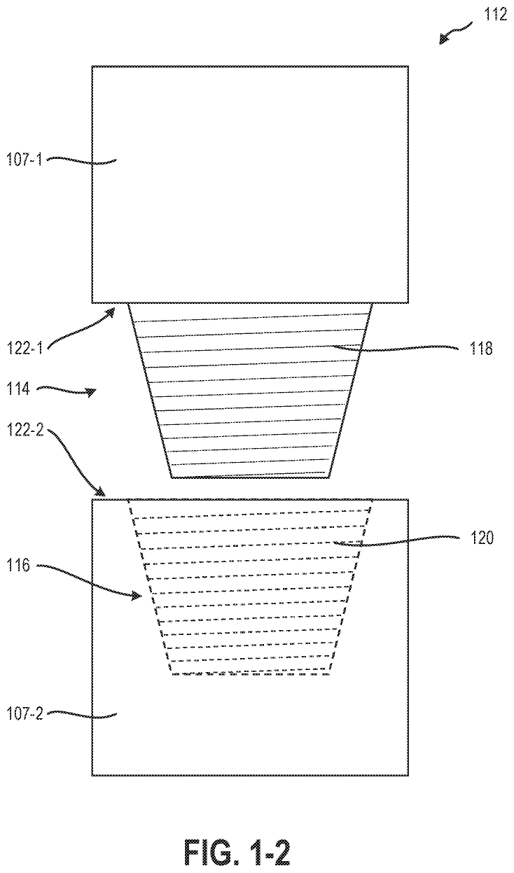

FIG. 1-2 is a representation of a joint connection 112 of the casing 107 of FIG. 1-1 between a first casing segment 107-1 and a second casing segment 107-2. In the embodiment shown, the joint connection 112 includes a pin-and-box threaded connection, however it should be understood that the techniques of the present disclosure may be applied to other connection mechanisms. The first casing segment 107-1 includes a pin end 114 and the second casing segment 107-2 includes a box end 116. The pin end 114 includes pin threads 118 and the box end 116 includes box threads 120.

The pin threads 118 and the box threads 120 may be complementary. Put another way, the pin threads 118 may be rotated to mate with and form a seal against the box threads 120. For example, when properly aligned, the pin threads 118 may insert into the 120 such that the protruding portion of the pin threads 118 may fit into the indentations or valleys between the box threads 120. As the first casing segment 107-1 is rotated relative to the second casing segment 107-2, contact of the pin threads 118 and the box threads 120 may cause the pin end 114 to travel into the box end 116. In some embodiments, the first casing segment 107-1 may travel toward the second casing segment 107-2 until a first shoulder 122-1 of the first casing segment 107-1 engages a second shoulder 122-2 of the second casing segment 107-2.

During installation, a sealing compound (e.g., casing dope) may be applied to the pin threads 118 and/or the box threads 120. As the pin end 114 is threaded into the box end 116, the sealing compound may be spread into the space between the pin threads 118 and the box threads 120. The sealing compound may help to form a seal between outside and inside the first casing segment 107-1 and the second casing segment 107-2, help improve temperature resistance, provide lubrication between the pin threads 118 and the box threads 120 during installation, prevent undesired de-threading of the pin end 114 and the box end 116 after the sealing compound has set, and so forth.

The connection between the first casing segment 107-1 and the second casing segment 107-2 may have a joint quality score. The joint quality score may be a representation of various metrics associated with the joint connection 112. For example, the joint quality score may be a representation of whether the joint connection 112 meets minimum standards of sealing, pressure, structural integrity, torque resistance, temperature resistance, any other metric, and combinations thereof. A high joint quality score may indicate that the completed joint connection 112 meets or exceeds the pre-determined standards. A low joint quality score may indicate that the completed joint connection 112 does not meet one or more of the pre-determined standards.

As discussed herein, during connection of the joint connection 112, a torque sensor may monitor the torque applied to the first casing segment 107-1 and/or the second casing segment 107-2. For example, the first casing segment 107-1 may be located in the rig and the top drive may rotate the first casing segment 107-1 with respect to the second casing segment 107-2. However, it should be understood that the first casing segment 107-1 may include a box connection and/or that the second casing segment 107-2 may be rotated with respect to the first casing segment 107-1.

In accordance with at least one embodiment of the present disclosure, a casing connection management system may monitor the torque-turns dataset generated when the first casing segment 107-1 is connected to the second casing segment 107-2. The casing connection management system may be trained to generate a joint quality score based on the torque-turns dataset. For example, the casing management system may include a deep learning model trained to identify patterns in the torque-turns dataset, the patterns associated with joint quality scores.

A poor joint connection may be a result of any portion of the joint connection 112 not connecting in a desirable manner. For example, a poor joint connection may be a result of cross-threading between the pin threads 118 and the box threads 120. Cross-threading may occur with the pin threads 118 and the box threads 120 are not aligned. Attempting to rotate a cross-threaded joint connection 112 may result in sharp increases in the torque followed by a period of rotation include a low increase or decrease in torque. A cross-threaded joint connection 112 may not form a seal and/or may have poor structural integrity. Other examples of conditions resulting in a poor joint connection include improper application of the sealing compound (e.g., too much, too little, uneven application), wear on the pin threads 118 and/or the box threads 120, different connection types, different casing sizes, any other condition, and combinations thereof.

In some embodiments, when the casing connection management system generates a poor joint quality score for the joint connection 112, the joint connection 112 is disassembled and reassembled. In some embodiments, when the casing connection management system generates a poor joint quality score for the joint connection 112, the casing segment first 107-1, which is not installed in the wellbore, may be replaced. In this manner, the casing connection management system may help to reduce or prevent installation of casing 107 having poor joint connections 112.

FIG. 2-1 through FIG. 2-4 are representations of torque-turns datasets (collectively 224) illustrating torque on the y-axis (e.g., vertical axis) and rotational position (e.g., turns) on the x-axis (e.g., horizontal axis), according to at least one embodiment of the present disclosure. A particular joint connection may include a joint connection type. The joint connection type may have a pre-determined joint connection pattern. For example, FIG. 2-1 illustrates a first torque-turns dataset 224-1 illustrating a pre-determined specification of the joint connection pattern. The first torque-turns dataset 224-1 illustrated includes a thread engagement zone 226, a seal engagement zone 228, and a shoulder engagement zone 230. In the pattern shown, the torque increases gradually in the thread engagement zone 226, then faster in the seal engagement zone 228, with a steep spike in torque in the shoulder engagement zone 230. In the thread engagement zone 226, the threads are in contact and engaging, in the seal engagement zone 228, the sealing compound is spread along the connection and the threads, and in the shoulder engagement zone 230, the shoulders of casing segments are in contact. The torque ends at or near a desired torque 232, which is between a minimum torque 234 and a maximum torque 236. A high quality joint connection (e.g., a joint connection receiving a good joint score) may have a profile or a pattern that matches or approximately mattes the profile shown in first torque-turns dataset 224-1.

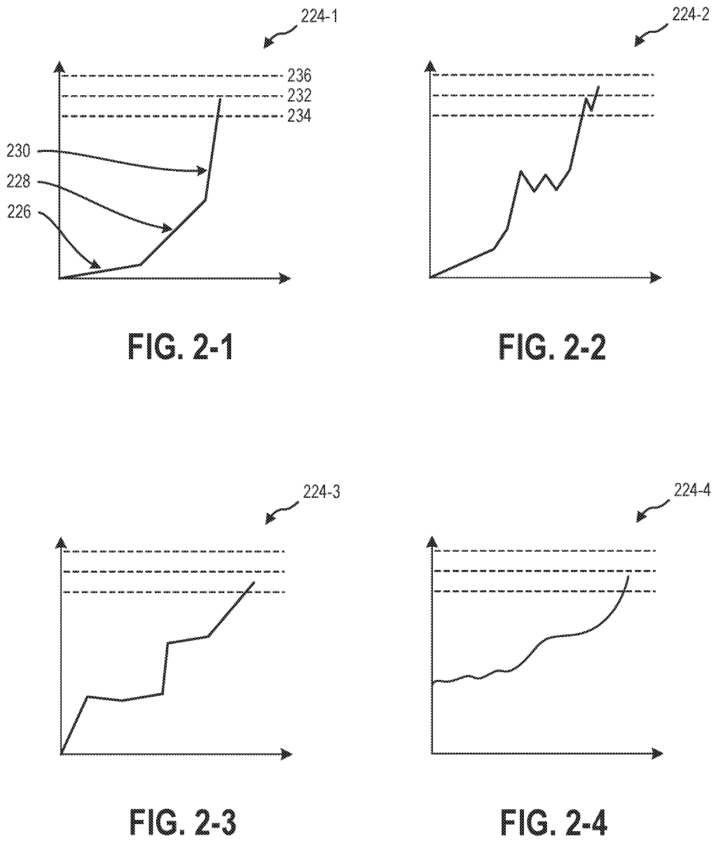

FIG. 2-2 through FIG. 2-4 represent poor quality joint connections. Note that each of the torque-turns datasets 224 illustrated in FIG. 2-2 through FIG. 2-5 have torque values that end between the minimum torque 234 and the maximum torque 236. In FIG. 2-2, a second torque-turns dataset 224-2 illustrates an erratic pattern, including portions of increase and decrease in the torque values. A high degree of erraticism may indicate a poor joint quality, such as due to cross-threading. In FIG. 2-3, a third torque-turns dataset 224-3 illustrates a steep increase in torque in what should be the seal engagement zone 228. In FIG. 2-4, a fourth torque-turns dataset 224-4 illustrates a starting torque that is greater than zero.

In accordance with at least one embodiment of the present disclosure, a deep learning model may be trained to identify torque-turns datasets 224 that have a poor connection quality. For example, the second torque-turns dataset 224-2, third torque-turns dataset 224-3, and the fourth torque-turns dataset 224-4 may be included in a training dataset to train the deep learning model. In some examples, datasets having a high joint quality score (e.g., a pattern similar to the first torque-turns dataset 224-1) are included in the training dataset. When the deep learning model is trained on the training dataset, the deep learning model may generate joint quality scores for inputted torque-turns datasets.

FIG. 3 is a schematic representation of a casing connection management system 338, according to at least one embodiment of the present disclosure. A casing installation manager 340 may begin installing a casing connection between a first casing segment and a second casing segment. During installation of the casing, torque-turns measurements may be measured with one or more sensors 342. The sensors 342 may measure rotational position, including number of rotations and partial rotational position. The sensors 342 may further measure torque. In some embodiments, the sensors 342 may measure rotational position and torque simultaneously. For example, when a rotational sensor measures the rotational position, a torque sensor may measure torque. In some examples, when a torque sensor measures the torque, the rotational sensor measures the rotational position. In some embodiments, the sensors 342 measure rotational position and torque at different times and/or on different schedules. For example, the sensors may measure rotational position and torque based on time, and the torque-turns information may be synchronized based on the time.

A torque-turns data manager 344 may receive the rotation and torque measurements from the sensors 342. The torque-turns data manager 344 may obtain a torque-turns dataset from the sensors 342. For example, the torque-turns data manager 344 may obtain a dataset of torque-turns measurements associated with a single joint connection. The torque-turns data manager 344 may obtain the torque-turns dataset in any manner. For example, the torque-turns data manager 344 may obtain the torque-turns dataset as a series of numerical values. In some examples, the torque-turns data manager 344 may obtain the torque-turns dataset as a graph, including an image of a graph. In some examples, the torque-turns data manager 344 may receive the torque-turns dataset as a series of numerical values and convert the torque-turns dataset to a graph. In some examples, the torque-turns data manager 344 may receive the torque-turns dataset as a graph and convert the torque-turns dataset to numerical values (such as through image processing, including assigning numerical values based on a pixel's position relative to a pre-determined scale).

In some embodiments, the torque-turns data manager 344 scales the torque-turns dataset to a pre-determined scale. For example, the torque-turns data manager 344 may scale the rotational position of the torque-turns dataset to a percentage of a pre-determined maximum number of rotations. In some examples, the torque-turns data manager 344 may then convert the percentage to a number of rotations. In some examples, the torque-turns data manager 344 may scale the torque value of the torque-turns dataset to a percentage of a pre-determined maximum torque. In some examples, the torque-turns data manager 344 may then convert the percentage to a torque value.

The torque-turns data manager 344 may provide the torque-turns dataset to a deep learning model 346. The deep learning model 346 may analyze the torque-turns dataset. For example, the deep learning model 346 may generate a joint quality score for the connection based on the torque-turns dataset. The deep learning model 346 may generate any type of joint quality score. For example, the deep learning model 346 may generate a good joint quality score indicating that the joint connection meets or exceeds the pre-determined standards. In some examples, the deep learning model 346 may generate a poor joint quality score indicating that the joint connect does not meet the pre-determined standards. In some examples, the deep learning model 346 may generate an indeterminate joint quality score indicating that the deep learning model 346 cannot state, with a sufficient degree of accuracy, whether the joint connection is good quality or poor quality.

The deep learning model 346 may be in communication with the casing installation manager 340. For example, when the casing installation manager 340 identifies the joint quality score, the casing installation manager 340 may transmit the joint quality score to the casing installation manager 340. The casing installation manager 340 may make a decision based on the joint quality score. For example, the casing installation manager 340 may, upon receipt of a good joint quality score, approve the joint connection and continue to install the casing. In some examples, the casing installation manager 340 may, upon receipt of a poor joint quality score, not approve the joint connection. The casing installation manager 340 may cause the casing connection to be removed and re-installed and/or a new casing segment installed.

In some examples, the casing installation manager 340 may, upon receipt of a poor joint quality score and/or an indeterminate joint quality score, send the torque-turns dataset to a human operator. The human operator may review the torque-turns dataset and make the ultimate decision regarding joint connection quality. In this manner, the casing connection management system 338 may facilitate an automated approval process for casing installation, with human approval for indeterminate connections.

In some embodiments, two or more elements of the casing connection management system 338 are in direct communication. For example, the torque-turns data manager 344, the deep learning model 346, and/or the casing installation manager 340 may be located on the same computing device, same server, in wired communication, or otherwise directly connected. In some embodiments, the elements of the casing connection management system 338 may be connected over a network 348. The network 348 may be any type of network, including a wireless network, a local network, the internet, any other network, and combinations thereof.

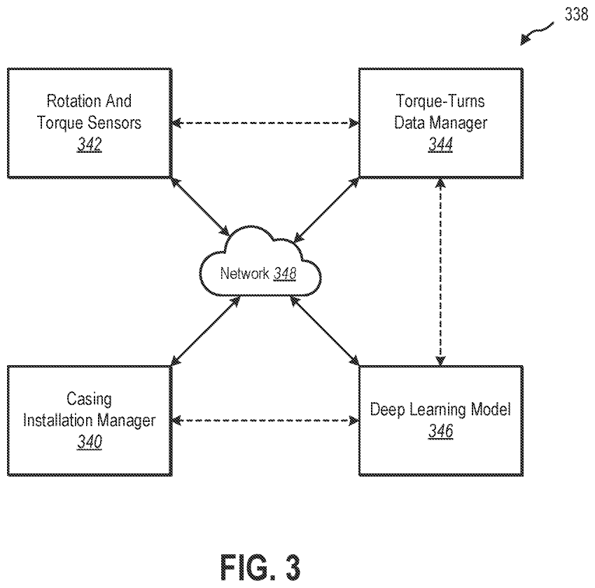

FIG. 4 is a representation of a casing connection management system 438, according to at least one embodiment of the present disclosure. Each of the components of the casing connection management system 438 may include software, hardware, or both. For example, the components may include one or more instructions stored on a computer-readable storage medium and executable by processors of one or more computing devices, such as a client device or server device. When executed by the one or more processors, the computer-executable instructions of the casing connection management system 438 may cause the computing device(s) to perform the methods described herein. Alternatively, the components may include hardware, such as a special-purpose processing device to perform a certain function or group of functions. Alternatively, the components of the casing connection management system 438 may include a combination of computer-executable instructions and hardware.

Furthermore, the components of the casing connection management system 438 may, for example, be implemented as one or more operating systems, as one or more stand-alone applications, as one or more modules of an application, as one or more plug-ins, as one or more library functions or functions that may be called by other applications, and/or as a cloud-computing model. Thus, the components may be implemented as a stand-alone application, such as a desktop or mobile application. Furthermore, the components may be implemented as one or more web-based applications hosted on a remote server. The components may also be implemented in a suite of mobile device applications or “apps.”

The casing connection management system 438 may include sensors 442. The sensors 442 may include a torque sensor 450. The torque sensor 450 may measure the torque applied to one or both of the casing segments during connection of the casing segments. The sensors 442 may further include a rotational position sensor 452. The rotational position sensor 452 may measure the rotational position of the casing segments with respect to each other, including total number of rotations and partial rotations.

The casing connection management system 438 may include a torque-turns data manager 444. The torque-turns data manager 444 may obtain the torque and rotational position information from the sensors 442. As discussed herein, the torque-turns data manager 444 may obtain the torque and rotational position information in any manner. For example, the torque-turns data manager 444 may receive graphical information including an image of a torque-turns graph. In some examples, the torque-turns data manager 444 may receive numerical information of torque associated with numerical position.

The torque-turns data manager 444 may prepare the torque-turns dataset for processing by a deep learning model 446. For example, the torque-turns data manager 444 may include a data scaling manager 454. The data scaling manager 454 may scale a torque-turns dataset to a pre-determined scale or a pre-determined value. The deep learning model 446 may be trained on a particular torque or total rotations scale. Scaling the torque-turns dataset to the pre-determined scale may help to improve the accuracy of the analysis by the deep learning model 446.

The torque-turns data manager 444 may include a graph processing manager 456. The graph processing manager 456 may process image-based torque-turns datasets. For example, the torque-turns data manager 444 may receive a graphical image of a torque-turns dataset. The graph processing manager 456 may process the graphical image based on a preferred input for the deep learning model 446. For example, the graph processing manager 456 may adjust the contrast, the size, the orientation, the clarity, the color scheme, or other aspect of image-based torque-turns datasets.

In some embodiments, the graph processing manager 456 may convert a numerical torque-turns dataset to a graphical or image-based torque-turns dataset. The deep learning model 446 may be trained based on graphical or image-based torque-turns datasets. To improve the accuracy and/or relevance of the joint quality score by the deep learning model 446, the graph processing manager 456 may convert the numerical torque-turns dataset to a graphical or an image-based torque-turns dataset.

In some embodiments, the graph processing manager 456 may convert a graphical torque-turns dataset to a numerical torque-turns dataset. The deep learning model 446 may be trained based on numerical torque-turns datasets. To improve the accuracy and/or relevance of the joint quality score by the deep learning model 446, the graph processing manager 456 may convert the graphical torque-turns dataset to a numerical torque-turns dataset.

The torque-turns data manager 444 may include a training dataset manager 458. The training dataset manager 458 may generate a training dataset to train the deep learning model 446. For example, the training dataset manager 458 may obtain a plurality of torque-turns datasets from the sensors 442. The training dataset manager 458 may receive, such as from a trained operator, joint quality scores for each of the torque-turns datasets. The training dataset manager 458 may separate the torque-turns datasets to a training dataset and a validation dataset. The torque-turns data manager 444 may send the training dataset to the deep learning model 446 to train the deep learning model 446.

To generate the training dataset, the elements of the torque-turns data manager 444 may process the torque-turns datasets. For example, the training dataset manager 458 may cause the data scaling manager 454 to scale torque-turns datasets in the training dataset to the pre-determined scale. In some examples, the training dataset manager 458 may instruct the graph processing manager 456 to process the graphical images to comply with the input standards to train the deep learning model 446.

In accordance with at least one embodiment of the present disclosure, the graph processing manager 456 may generate multiple torque-turns datasets from a single torque-turns dataset by adjusting image properties of the single torque-turns dataset. For example, the graph processing manager 456 may adjust the contrast, the color, the background, the foreground, and other elements of the single torque-turns dataset. This may increase the number of torque-turns datasets included in the training dataset. As a specific example, the graph processing manager 456 may increase the number of good joint quality scores to facilitate training the deep learning model 446 to identify good joint quality scores.

The deep learning model 446 may include a joint quality score generator 460. Training the deep learning model 446 may include training the joint quality score generator 460 to identify a joint quality score. In some embodiments, training the deep learning model 446 may include training the joint quality score generator 460 to over-represent poor joint quality scores and/or indeterminate joint quality scores. For example, during training of the deep learning model 446, a constraint may be placed on the deep learning model 446 that results in over-identification of poor joint quality scores and/or indeterminate joint quality scores. Over-identification of poor and/or indeterminate joint quality scores may help to prevent or reduce the installation of casings having poor joint connections.

The casing connection management system 438 may further include a casing installation manager 440. As discussed herein, the casing installation manager 440 may receive the joint quality score from the deep learning model 446. Based on the joint quality score, the casing installation manager 440 may continue to install additional casing segments or may cause the casing segment having the poor joint quality score to be removed.

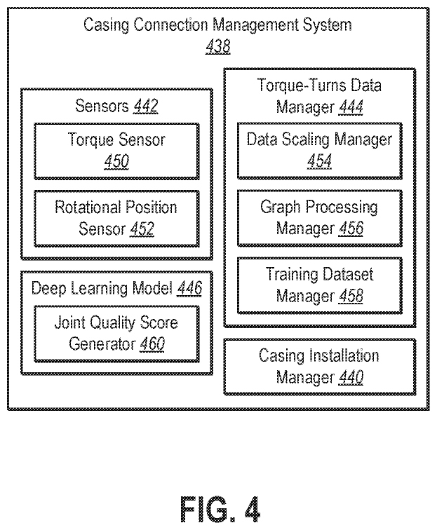

FIG. 5 is a representation of a deep learning model training system 562, according to at least one embodiment of the present disclosure. The deep learning model training system 562 may train a deep learning model to generate joint quality scores. As may be understood, the deep learning model training system 562 may train any type of deep learning model. The type of deep learning model trained by the deep learning model training system 562 may be any type of deep learning model. In some embodiments, the deep learning model trained by the deep learning model training system 562 is based on the format or type of received torque-turns datasets 564. For example, graphical torque-turns datasets 564 may be used to train a convoluted neural network. In some examples, numerical torque-turns datasets 564 may be used to train a deep belief network or other deep learning model. However, it should be understood that any type of deep learning model may be trained with any type of input torque-turns datasets 564.

To train the deep learning model, a plurality of torque-turns datasets 564 may be split into a training dataset 566 and a validation dataset 568. The training dataset 566 may be input to a deep learning model 546 to train the deep learning model 546. As discussed herein, the training dataset 566 may be processed prior to training the deep learning model 546. For example, the torque-turns datasets may be scaled to a pre-determined scale. In some examples, images of the torque-turns datasets may be modified to increase the size of the training dataset 566, such as by changing contrast, background colors, foreground colors, and so forth.

Each of the torque-turns datasets 564 may be associated with a particular connection type. Connection types may vary between manufacturers, and may have different joint connection shapes, profiles, torque limits, rotation limits, and so forth. In some embodiments, a different deep learning model 546 may is trained based on received torque-turns datasets 564 for a particular connection type. This may help to ensure that the deep learning model 546 identifies joint quality scores for the desired connection type, thereby improving the accuracy of the resulting joint quality scores.

In accordance with at least one embodiment of the present disclosure, the deep learning model 546 may not have as inputs or constraints any parameters used to determine the joint quality score. For example, the deep learning model 546 may not have as constraints any of the specified torque limits (e.g., minimum torque, maximum torque, desired torque), the specified rotation limits (e.g., minimum number of rotations, maximum number of rotations, desired number of rotations), a specified shape (including slopes, average values, torque values at particular rotational positions), any other input or constraint, and combinations thereof.

Each of the received torque-turns datasets 564 may include an associated joint quality score. When the deep learning model 546 obtains the received torque-turns datasets 564, the deep learning model 546 may analyze a torque-turns dataset to generate an output quality score 570.

The deep learning model training system 562 may include a quality score check 572. The quality score check 572 may check the quality score of the analyzed torque-turns dataset. Based on the quality score check 572, the deep learning model 546 may be re-trained. For example, if the quality score check 572 indicates that the output quality score 570 is not the same as the input output quality score 570, the deep learning model 546 may be re-trained, adjusting the weight of one or more nodes comprising the deep learning model 546.

The deep learning model 546 may be validated using the validation dataset 568. Validating the deep learning model 546 may include inputting the torque-turns datasets from the validation dataset 568 without the joint quality score. The deep learning model 546 may generate a joint quality score for the torque-turns datasets in the validation dataset 568. The output quality score 570 may be checked by the quality score check 572 to the joint quality score from the validation dataset 568.

As discussed herein, the deep learning model 546 may be trained to over-emphasize poor joint quality scores and/or indeterminate joint quality scores. For example, during validation, the deep learning model 546 may be re-trained if a torque-turns dataset receives a good joint quality score, but the validated joint-quality score is poor. In some embodiments, the deep learning model 546 may validated if none of the identified output quality scores 570 are identified as good when they should be identified as poor. The deep learning model 546 may still be validated if one or more output quality score 570 are identified as a poor or indetermined joint quality score when they should be identified as good. As discussed herein, this conservative identification of the joint quality score may facilitate a reduction or elimination of the installation of joints having a poor quality.

When the deep learning model 546 has been validated, a new torque-turns dataset 574 may be input to the deep learning model 546. The deep learning model 546 may generate an output quality score 570 based on the new torque-turns dataset 574. As discussed herein, a casing installation manager may make casing installation decisions based on the output quality score 570. For example, the casing installation manager may determine whether to re-do the casing connection, remove the casing connection, or approve the casing connection based on the output quality score 570. In some embodiments, the casing installation manager provides the new torque-turns dataset 574 to an operator based on the output quality score 570.

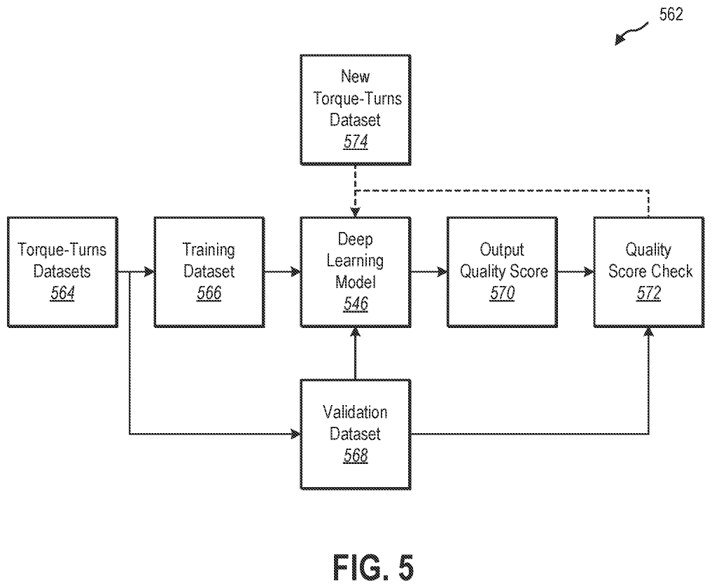

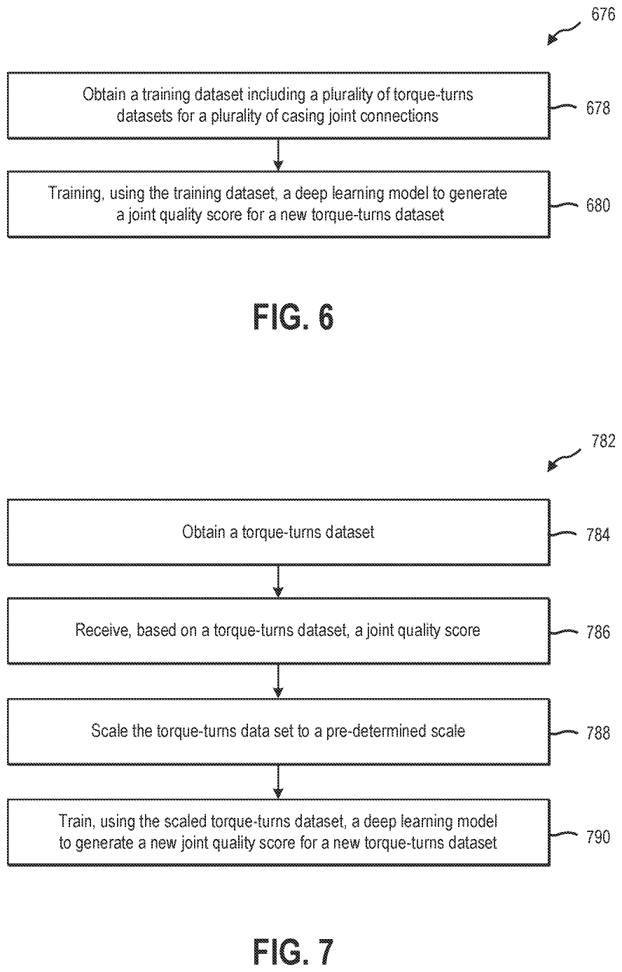

FIG. 6-7, the corresponding text, and the examples provide a number of different methods, systems, devices, and computer-readable media of the casing connection management system. In addition to the foregoing, one or more embodiments may also be described in terms of flowcharts comprising acts for accomplishing a particular result, as shown in FIG. 6-7. FIG. 6-7 may be performed with more or fewer acts. Further, the acts may be performed in differing orders. Additionally, the acts described herein may be repeated or performed in parallel with one another or parallel with different instances of the same or similar acts.

As mentioned, FIG. 6 illustrates a flowchart of a series of acts or a method 676 for classifying casing joint connections for casing in a wellbore, according to at least one embodiment of the present disclosure. While FIG. 6 illustrates acts according to one embodiment, alternative embodiments may omit, add to, reorder, and/or modify any of the acts shown in FIG. 6. The acts of FIG. 6 may be performed as part of a method. Alternatively, a computer-readable medium may comprise instructions that, when executed by one or more processors, cause a computing device to perform the acts of FIG. 6. In some embodiments, a system may perform the acts of FIG. 6.

A casing installation manager may obtain a training dataset including a plurality of torque-turns datasets for a plurality of casing joint connections at 678. Each of the plurality of torque-turns datasets may include a joint quality score for an associated casing joint connection of the plurality of casing joint connections. For example, the training dataset may include torque-turns datasets for historical wellbores. The wellbores may include casing joint connections having the same connection type or connection properties.

The casing installation manager may train, using the training dataset, a deep learning model to generate a new joint quality score for a new torque-turns dataset at 678. The new torque-turns dataset may be a torque-turns dataset from a casing joint connecting being installed in an active wellbore. Generating the new joint quality score may facilitate the casing installation manager to determine whether the casing joint connection quality is good or poor in real-time, or before the casing is installed and/or grouted in the wellbore.

In some embodiments, as discussed herein, training the deep learning model may include training the deep learning model based on a constraint to over-generate a poor joint quality score. This may facilitate reducing or preventing installation of casings having poor joint casing joint connections.

In some embodiments, obtaining the training dataset includes receiving the plurality of torque-turns datasets and processing the plurality of torque-turns datasets. Processing the torque-turns datasets may include scaling the plurality of torque-turns datasets to a pre-determined scale.

In some embodiments, as discussed herein, obtaining the training dataset includes obtaining the training dataset for a casing connection type. Training the deep learning model may include training the deep model for the casing connection type.

In some embodiments, inputting the new torque-turns dataset to the deep learning model to generate the new joint quality score. The new joint quality score may be associated with the new torque-turns dataset.

In some embodiments, when the new joint quality score is above a threshold (e.g., a good joint quality score), the casing installation manager may install a casing segment associated with the new torque-turns dataset in a wellbore. When the new joint quality score is below a threshold (e.g., a poor joint quality score), the casing installation manager may disconnect the casing segment associated with the new torque-turns dataset.

In some embodiments, as discussed herein, the plurality of torque-turns datasets include a plurality of graphs illustrating torque with respect to number of rotations. In some embodiments, the plurality of torque-turns datasets each include a plurality of torque measurements at a plurality of rotational positions. In some embodiments, the deep learning model includes a convoluted neural network.

As mentioned, FIG. 7 illustrates a flowchart of a series of acts or a method 782 for classifying casing joint connections for casing in a wellbore, according to at least one embodiment of the present disclosure. While FIG. 7 illustrates acts according to one embodiment, alternative embodiments may omit, add to, reorder, and/or modify any of the acts shown in FIG. 7. The acts of FIG. 7 may be performed as part of a method. Alternatively, a computer-readable medium may comprise instructions that, when executed by one or more processors, cause a computing device to perform the acts of FIG. 7. In some embodiments, a system may perform the acts of FIG. 7.

A casing installation manager may obtain a torque-turns dataset at 784. The torque-turns dataset may include a plurality of rotation-series torque measurements. The rotation-series torque measurements may include torque measurements measured at a particular rotational position. For example, rotation-series torque measurements may include torque measurements paired with rotational position measurements. In some examples, rotation-series torque measurements may include torque measurements measured at certain rotational positions. In some examples, the rotation-series torque measurements may include any measurement scheme between torque measurements and rotation measurements.

The casing installation manager may receive, based on the torque turns dataset, including the rotation-series measurements, and based on a pre-determined standard, a joint quality score at 786. The casing installation manager may scale the torque-turns dataset, including the rotation-series measurements, to a pre-determined scale based on the pre-determined standard. The casing installation manager may train, using the scaled torque-turns dataset, a deep learning model to generate a new joint quality score for a new torque-turns dataset.

As discussed herein, training the deep learning model may include training the deep learning model based on a constraint to over-generate a poor-joint quality score.

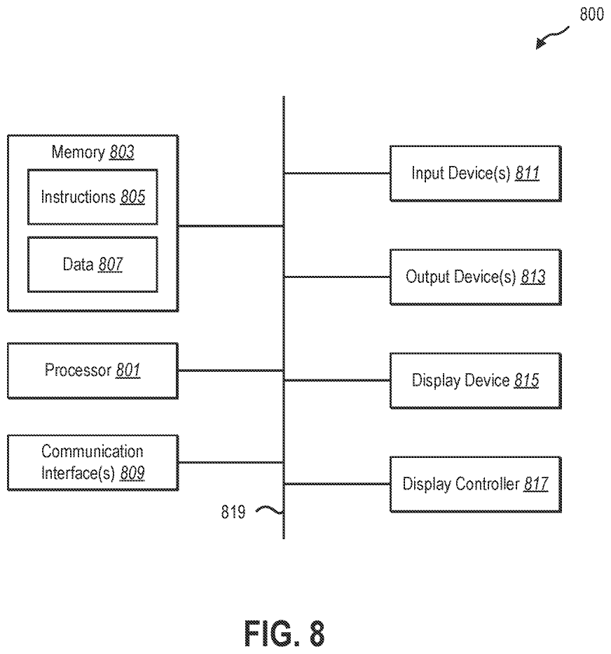

FIG. 8 illustrates certain components that may be included within a computer system 800. One or more computer systems 800 may be used to implement the various devices, components, and systems described herein.

The computer system 800 includes a processor 801. The processor 801 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 801 may be referred to as a central processing unit (CPU). Although just a single processor 801 is shown in the computer system 800 of FIG. 8, in an alternative configuration, a combination of processors (e.g., an ARM and DSP) could be used.

The computer system 800 also includes memory 803 in electronic communication with the processor 801. The memory 803 may be any electronic component capable of storing electronic information. For example, the memory 803 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 805 and data 807 may be stored in the memory 803. The instructions 805 may be executable by the processor 801 to implement some or all of the functionality disclosed herein. Executing the instructions 805 may involve the use of the data 807 that is stored in the memory 803. Any of the various examples of modules and components described herein may be implemented, partially or wholly, as instructions 805 stored in memory 803 and executed by the processor 801. Any of the various examples of data described herein may be among the data 807 that is stored in memory 803 and used during execution of the instructions 805 by the processor 801.

A computer system 800 may also include one or more communication interfaces 809 for communicating with other electronic devices. The communication interface(s) 809 may be based on wired communication technology, wireless communication technology, or both. Some examples of communication interfaces 809 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 800 may also include one or more input devices 811 and one or more output devices 813. Some examples of input devices 811 include a keyboard, mouse, microphone, remote control device, button, joystick, trackball, touchpad, and lightpen. Some examples of output devices 813 include a speaker and a printer. One specific type of output device that is typically included in a computer system 800 is a display device 815. Display devices 815 used with embodiments disclosed herein may utilize any suitable image projection technology, such as liquid crystal display (LCD), light-emitting diode (LED), gas plasma, electroluminescence, or the like. A display controller 817 may also be provided, for converting data 807 stored in the memory 803 into text, graphics, and/or moving images (as appropriate) shown on the display device 815.

The various components of the computer system 800 may be coupled together by one or more buses, which may include a power bus, a control signal bus, a status signal bus, a data bus, etc. For the sake of clarity, the various buses are illustrated in FIG. 8 as a bus system 819.

### INDUSTRIAL APPLICABILITY

This disclosure generally relates to devices, systems, and methods for utilizing a deep neural network to generate a joint quality score for a casing joint connection. Casing is installed in a wellbore for a variety of reasons, including to prevent ingress of fluids into the wellbore, prevent egress of fluids out of the wellbore, increase wellbore stability, any other reason, and combinations thereof. Typically, casing includes two or more steel casing sections (e.g., cylindrical steel pipes or tubes) connected with a threaded connection. The casing sections are inserted into the wellbore. Grout or cement may be pumped into the annulus between the casing and the wellbore wall. Once the grout is installed, removal, repair, replacement, or other actions on the casing sections is time-consuming and expensive, and may carry risk of damage to the wellbore.

The casing connection may be categorized with a joint quality score. The joint quality score may be a representation of the quality of the connection between two casing connections. A high joint quality score may represent a joint connection that meets a specified sealing pressure and/or a specified structural strength. A poor casing connection may represent a joint connection that does not meet the specified sealing pressure and/or the specified structural strength. Thus, a poor casing connection may result in a casing failure. For example, the casing connection may not form a seal between the two casing sections. This may result in undesired fluid ingress or egress at the casing connection. In some embodiments, a poor casing connection may result in structural damage to the casing at the joint. Repair of the installed casing after casing joint connection may be time-consuming and expensive.

In some embodiments, two casing sections are connected with a threaded connection. To connect the sections, the casing sections are rotated relative to each other. This may result in an applied torque on the casing sections. In some situations, to determine the quality of the casing joint connection, an operator may analyze the torque with respect to rotational position while connecting the casing sections. The quality of the casing joint connection may be based on any torque-turns metric. For example, the quality of the casing joint connection may be based on whether the final torque is within a final torque range, or between a minimum torque and a maximum torque. In some examples, the quality of the casing joint connection may be based on whether the final number of turns is within a final rotation range, or between a minimum number of rotations (e.g., a minimum number of turns) and a maximum number of rotations (e.g., a maximum number of turns). In some examples, the quality of the casing joint connection may be based on a pattern of the change in torque with respect to the number of rotations.

Conventionally, identifying the casing connection quality may be performed by a skilled operator. For example, in situations where the final torque is within the final torque range and/or when the final number of rotations is within the final rotation range, the torque-turns patterns may be used to determine the casing connection quality. But the operator that identifies the torque-turns patterns may utilize his or her extensive experience, education, and training to identify a poor quality casing connection. Maintaining such a person on a drilling rig to examine each casing connection may not be practical. Indeed, operators often analyze the casing connection quality after a failure is identified. Thus, typical drilling systems are often reactive to poor casing connection quality.

In accordance with at least one embodiment of the present disclosure, a deep learning model may be trained to identify the casing connection quality based on the torque-turns information. For example, the deep learning model may be trained on the torque-turns patterns to identify poor casing connection quality. When the deep learning model identifies a poor casing connection quality, the casing installation manager may stop the installation of the casing segment. In this manner, the deep learning model may reduce or prevent the installation of casing segments having a poor joint connection. This may help to improve the casing quality, thereby reducing damage to the wellbore based on poor casing connections.

In some embodiments, to train the deep learning model, the operator may input previously measured torque-turns datasets. The torque-turns datasets may include a joint quality score identified by an operator. The joint quality scores may include a high joint quality (e.g., the joint meets or exceeds the pre-determined standards), a low joint quality (e.g., the joint is below the pre-determined standards), or an indeterminate joint quality (e.g., the joint quality is unable to be determined based on the torque-turns pattern). The deep learning model may analyze the training dataset of previously measured torque-turns datasets to learn to identify the joint quality score.

In accordance with at least one embodiment of the present disclosure, the operator may pre-process the torque-turns datasets to generate the training dataset. For example, a torque-turns data manager may scale the torque-turns datasets to a scale associated with the casing connection type. This may help the deep learning model to analyze the torque-turns datasets based on the same scale. In some examples, the torque-turns data manager may adjust image properties of a torque-turns graph to increase the number of torque-turns datasets used to train the deep learning model. This may provide the deep learning model with additional torque-turns datasets used in training, thereby improving the accuracy and/or relevance of the results of the deep learning model.

In some embodiments, the deep learning model is trained to over-identify casing connections having a poor connection quality. For example, the deep learning model may include a constraint to conservatively identify poor casing connections. Over-identifying poor connection quality may help to ensure that no casing connections installed with a poor quality. In this manner, the deep learning model may facilitate improved casing quality, thereby reducing damage to the wellbore based on poor casing connections.

As illustrated by the foregoing discussion, the present disclosure utilizes a variety of terms to describe features and advantages of the casing connection management system discussed herein. Additional detail is now provided regarding the meaning of such terms. For example, as used herein, the term “deep learning model” refers to a type of machine learning (ML) model including multiple layers of interconnected nodes. The layers may include visible layers, such as an input layer and an output layer, and hidden layers, which may perform analysis and computations based on the input data and data received from other nodes. The cross-layer interconnected nodes may process and transform input data. Each node in the layers may be configured to perform a specific task, such as communicate with other nodes, perform a computation, communicate with an output layer, and so forth. The number of nodes in the deep learning model may be a hyperparameter that is tuned to impact the model performance. As the deep neural model is trained, the weights of the various nodes may be adjusted based on a particular constraint or desired outcome. Examples of deep learning models include multi-layer perceptron (MLP), convolutional neural network (CNN), recurrent neural network (RNN), long short-term memory networks (LSTM), generative adversarial networks (GAN), autoencoders, transformers, any other neural network or deep neural model, and combinations thereof.

A drilling system includes a drill rig used to turn a drilling tool assembly which extends downward into the wellbore. The drilling tool assembly may include a drill string, a bottomhole assembly (“BHA”), and a bit, attached to the downhole end of drill string.

The drill string may include several joints of drill pipe connected end-to-end through tool joints. The drill string transmits drilling fluid through a central bore and transmits rotational power from the drill rig to the BHA. In some embodiments, the drill string may further include additional components such as subs, pup joints, etc. The drill pipe provides a hydraulic passage through which drilling fluid is pumped from the surface. The drilling fluid discharges through selected-size nozzles, jets, or other orifices in the bit for the purposes of cooling the bit and cutting structures thereon, and for lifting cuttings out of the wellbore as it is being drilled.

The BHA may include the bit or other components. An example BHA may include additional or other components (e.g., coupled between to the drill string and the bit). Examples of additional BHA components include drill collars, stabilizers, measurement-while-drilling (“MWD”) tools, logging-while-drilling (“LWD”) tools, downhole motors, underreamers, section mills, hydraulic disconnects, jars, vibration or dampening tools, other components, or combinations of the foregoing. The BHA 106 may further include a rotary steerable system (RSS). The RSS may include directional drilling tools that change a direction of the bit, and thereby the trajectory of the wellbore. At least a portion of the RSS may maintain a geostationary position relative to an absolute reference frame, such as gravity, magnetic north, and/or true north. Using measurements obtained with the geostationary position, the RSS may locate the bit, change the course of the bit, and direct the directional drilling tools on a projected trajectory.

In general, the drilling system may include other drilling components and accessories, such as special valves (e.g., kelly cocks, blowout preventers, and safety valves). Additional components included in the drilling system may be considered a part of the drilling tool assembly, the drill string, or a part of the BHA depending on their locations in the drilling system.

The bit in the BHA may be any type of bit suitable for degrading downhole materials. For instance, the bit may be a drill bit suitable for drilling the earth formation. Example types of drill bits used for drilling earth formations are fixed-cutter or drag bits. In other embodiments, the bit may be a mill used for removing metal, composite, elastomer, other materials downhole, or combinations thereof. For instance, the bit may be used with a whipstock to mill into casing 107 lining the wellbore. The bit may also be a junk mill used to mill away tools, plugs, cement, other materials within the wellbore, or combinations thereof. Swarf or other cuttings formed by use of a mill may be lifted to surface, or may be allowed to fall downhole.

As discussed herein, the casing may be installed in the wellbore to protect the wellbore. For example, the casing may help to prevent collapse of the wellbore from weak portions of the earth formation (including soil, sand, eroded strata, jointed strata, and other weak portions of the earth formation). The casing may further help to prevent the ingress of fluids into the wellbore and/or the egress of fluids out of the wellbore and into the surrounding earth formation.

During installation of the casing, a first casing segment may be at least partially inserted into the upper portion of the wellbore. A second casing segment may be suspended in the drill rig. A rotary element may rotate one of the casing segments relative to the other. For example, a top drive may rotate the upper casing segment in the drill rig with respect to the lower segment. One or more torque sensors in the drill rig may measure the applied torque to the casing segments. For example, the torque sensors may be located on the top drive and measure the torque the top drive applies to the upper casing segment. In some examples, the torque sensors may be located at any other location. A rotation sensor may sense the rotational position of the casing segments. For example, a rotation sensor on the top drive may detect the rotational position (including number of rotations and partial rotations) of the upper segment in the drill rig as the top drive rotates the upper casing segment.

A casing connection management system may include a deep learning network trained to monitor the torque applied to the casing segments with respect to the rotational position. For example, the casing connection management system may collect a torque-turns dataset including torque measured with respect to rotational position (e.g., rotation-series torque measurements) and/or rotational position measured with respect to torque (e.g., torque-series rotation measurements). The deep learning network may be trained to identify the joint connection quality of the joint between the two casing segments. The deep learning network may generate a joint quality score for the joint connection. If the deep learning network identifies a poor quality joint quality score, the drilling system 100 may disconnect the casing segments and reconnect them. This may facilitate improved and more reliable installation of high quality joint connections.

A joint connection 112 of a casing between a first casing segment 107-1 and a second casing segment 107-2 may include a pin-and-box threaded connection, however it should be understood that the techniques of the present disclosure may be applied to other connection mechanisms. The first casing segment includes a pin end and the second casing segment includes a box end. The pin end includes pin threads and the box end includes box threads.

The pin threads and the box threads may be complementary. Put another way, the pin threads may be rotated to mate with and form a seal against the box threads. For example, when properly aligned, the pin threads may insert into the box threads such that the protruding portion of the pin threads may fit into the indentations or valleys between the box threads. As the first casing segment is rotated relative to the second casing segment, contact of the pin threads and the box threads may cause the pin end to travel into the box end. In some embodiments, the first casing segment may travel toward the second casing segment until a first shoulder of the first casing segment engages a second shoulder of the second casing segment.

During installation, a sealing compound (e.g., casing dope) may be applied to the pin threads and/or the box threads. As the pin end is threaded into the box end, the sealing compound may be spread into the space between the pin threads and the box threads. The sealing compound may help to form a seal between outside and inside the first casing segment and the second casing segment, help improve temperature resistance, provide lubrication between the pin threads and the box threads during installation, prevent undesired de-threading of the pin end and the box end after the sealing compound has set, and so forth.

The connection between the first casing segment and the second casing segment may have a joint quality score. The joint quality score may be a representation of various metrics associated with the joint connection. For example, the joint quality score may be a representation of whether the joint connection meets minimum standards of sealing, pressure, structural integrity, torque resistance, temperature resistance, any other metric, and combinations thereof. A high joint quality score may indicate that the completed joint connection meets or exceeds the pre-determined standards. A low joint quality score may indicate that the completed joint connection does not meet one or more of the pre-determined standards.

As discussed herein, during connection of the joint connection, a torque sensor may monitor the torque applied to the first casing segment and/or the second casing segment. For example, the first casing segment may be located in the rig and the top drive may rotate the first casing segment with respect to the second casing segment. However, it should be understood that the first casing segment may include a box connection and/or that the second casing segment may be rotated with respect to the first casing segment.

In accordance with at least one embodiment of the present disclosure, a casing connection management system may monitor the torque-turns dataset generated when the first casing segment is connected to the second casing segment. The casing connection management system may be trained to generate a joint quality score based on the torque-turns dataset. For example, the casing management system may include a deep learning model trained to identify patterns in the torque-turns dataset, the patterns associated with joint quality scores.

A poor joint connection may be a result of any portion of the joint connection not connecting in a desirable manner. For example, a poor joint connection may be a result of cross-threading between the pin threads and the box threads. Cross-threading may occur with the pin threads and the box threads are not aligned. Attempting to rotate a cross-threaded joint connection may result in sharp increases in the torque followed by a period of rotation include a low increase or decrease in torque. A cross-threaded joint connection may not form a seal and/or may have poor structural integrity. Other examples of conditions resulting in a poor joint connection include improper application of the sealing compound (e.g., too much, too little, uneven application), wear on the pin threads and/or the box threads, different connection types, different casing sizes, any other condition, and combinations thereof.

In some embodiments, when the casing connection management system generates a poor joint quality score for the joint connection, the joint connection is disassembled and reassembled. In some embodiments, when the casing connection management system generates a poor joint quality score for the joint connection, the casing segment not installed in the wellbore may be replaced. In this manner, the casing connection management system may help to reduce or prevent installation of casing having poor joint connections.

In some embodiments, torque-turns datasets may include torque on the y-axis (e.g., vertical axis) and rotational position (e.g., turns) on the x-axis (e.g., horizontal axis), according to at least one embodiment of the present disclosure. A particular joint connection may include a joint connection type. The joint connection type may have a pre-determined joint connection pattern. For example, a particular first torque-turns dataset may be based on a pre-determined specification of the joint connection pattern. The first torque-turns dataset includes a thread engagement zone, a seal engagement zone, and a shoulder engagement zone. In the pattern discussed, the torque increases gradually in the thread engagement zone, then faster in the seal engagement zone, with a steep spike in torque in the shoulder engagement zone. In the thread engagement zone, the threads are in contact and engaging, in the seal engagement zone, the sealing compound is spread along the connection and the threads, and in the shoulder engagement zone, the shoulders of casing segments are in contact. The torque ends at or near a desired torque, which is between a minimum torque and a maximum torque. A high quality joint connection (e.g., a joint connection receiving a good joint score) may have a profile or a pattern that matches or approximately mattes the profile shown in first torque-turns dataset.

Some torque-turns datasets include poor quality joint connections. Note that each of the poor torque-turns datasets discussed herein may have torque values that end between the minimum torque and the maximum torque. A second torque-turns dataset may exhibit an erratic pattern, including portions of increase and decrease in the torque values. A high degree of erraticism may indicate a poor joint quality, such as due to cross-threading. A third torque-turns dataset 224-3 may exhibit a steep increase in torque in what should be the seal engagement zone. A fourth torque-turns dataset may exhibit a starting torque that is greater than zero.

In accordance with at least one embodiment of the present disclosure, a deep learning model may be trained to identify torque-turns datasets that have a poor connection quality. For example, the second torque-turns dataset, third torque-turns dataset, and the fourth torque-turns dataset may be included in a training dataset to train the deep learning model. In some examples, datasets having a high joint quality score (e.g., a pattern similar to the first torque-turns dataset) are included in the training dataset. When the deep learning model is trained on the training dataset, the deep learning model may generate joint quality scores for inputted torque-turns datasets.

In some embodiments, a casing installation manager may begin installing a casing connection between a first casing segment and a second casing segment. During installation of the casing, torque-turns measurements may be measured with one or more sensors. The sensors may measure rotational position, including number of rotations and partial rotational position. The sensors may further measure torque. In some embodiments, the sensors may measure rotational position and torque simultaneously. For example, when a rotational sensor measures the rotational position, a torque sensor may measure torque. In some examples, when a torque sensor measures the torque, the rotational sensor measures the rotational position. In some embodiments, the sensors measure rotational position and torque at different times and/or on different schedules. For example, the sensors may measure rotational position and torque based on time, and the torque-turns information may be synchronized based on the time.

A torque-turns data manager may receive the rotation and torque measurements from the sensors. The torque-turns data manager may obtain a torque-turns dataset from the sensors. For example, the torque-turns data manager may obtain a dataset of torque-turns measurements associated with a single joint connection. The torque-turns data manager may obtain the torque-turns dataset in any manner. For example, the torque-turns data manager may obtain the torque-turns dataset as a series of numerical values. In some examples, the torque-turns data manager may obtain the torque-turns dataset as a graph, including an image of a graph. In some examples, the torque-turns data manager may receive the torque-turns dataset as a series of numerical values and convert the torque-turns dataset to a graph. In some examples, the torque-turns data manager may receive the torque-turns dataset as a graph and convert the torque-turns dataset to numerical values (such as through image processing, including assigning numerical values based on a pixel's position relative to a pre-determined scale).

In some embodiments, the torque-turns data manager scales the torque-turns dataset to a pre-determined scale. For example, the torque-turns data manager may scale the rotational position of the torque-turns dataset to a percentage of a pre-determined maximum number of rotations. In some examples, the torque-turns data manager may then convert the percentage to a number of rotations. In some examples, the torque-turns data manager may scale the torque value of the torque-turns dataset to a percentage of a pre-determined maximum torque. In some examples, the torque-turns data manager may then convert the percentage to a torque value.

The torque-turns data manager may provide the torque-turns dataset to a deep learning model. The deep learning model may analyze the torque-turns dataset. For example, the deep learning model may generate a joint quality score for the connection based on the torque-turns dataset. The deep learning model may generate any type of joint quality score. For example, the deep learning model may generate a good joint quality score indicating that the joint connection meets or exceeds the pre-determined standards. In some examples, the deep learning model may generate a poor joint quality score indicating that the joint connect does not meet the pre-determined standards. In some examples, the deep learning model may generate an indeterminate joint quality score indicating that the deep learning model cannot state, with a sufficient degree of accuracy, whether the joint connection is good quality or poor quality.

The deep learning model may be in communication with the casing installation manager. For example, when the casing installation manager identifies the joint quality score, the casing installation manager may transmit the joint quality score to the casing installation manager. The casing installation manager may make a decision based on the joint quality score. For example, the casing installation manager may, upon receipt of a good joint quality score, approve the joint connection and continue to install the casing. In some examples, the casing installation manager may, upon receipt of a poor joint quality score, not approve the joint connection. The casing installation manager may cause the casing connection to be removed and re-installed and/or a new casing segment installed.

In some examples, the casing installation manager may, upon receipt of a poor joint quality score and/or an indeterminate joint quality score, send the torque-turns dataset to a human operator. The human operator may review the torque-turns dataset and make the ultimate decision regarding joint connection quality. In this manner, the casing connection management system may facilitate an automated approval process for casing installation, with human approval for indeterminate connections.

In some embodiments, two or more elements of the casing connection management system are in direct communication. For example, the torque-turns data manager, the deep learning model, and/or the casing installation manager may be located on the same computing device, same server, in wired communication, or otherwise directly connected. In some embodiments, the elements of the casing connection management system may be connected over a network. The network may be any type of network, including a wireless network, a local network, the internet, any other network, and combinations thereof.

A casing connection management system may include various components. Each of the components of the casing connection management system may include software, hardware, or both. For example, the components may include one or more instructions stored on a computer-readable storage medium and executable by processors of one or more computing devices, such as a client device or server device. When executed by the one or more processors, the computer-executable instructions of the casing connection management system may cause the computing device(s) to perform the methods described herein. Alternatively, the components may include hardware, such as a special-purpose processing device to perform a certain function or group of functions. Alternatively, the components of the casing connection management system may include a combination of computer-executable instructions and hardware.

Furthermore, the components of the casing connection management system may, for example, be implemented as one or more operating systems, as one or more stand-alone applications, as one or more modules of an application, as one or more plug-ins, as one or more library functions or functions that may be called by other applications, and/or as a cloud-computing model. Thus, the components may be implemented as a stand-alone application, such as a desktop or mobile application. Furthermore, the components may be implemented as one or more web-based applications hosted on a remote server. The components may also be implemented in a suite of mobile device applications or “apps.”

The casing connection management system may include sensors. The sensors may include a torque sensor. The torque sensor may measure the torque applied to one or both of the casing segments during connection of the casing segments. The sensors may further include a rotational position sensor. The rotational position sensor may measure the rotational position of the casing segments with respect to each other, including total number of rotations and partial rotations.

The casing connection management system may include a torque-turns data manager. The torque-turns data manager may obtain the torque and rotational position information from the sensors. As discussed herein, the torque-turns data manager may obtain the torque and rotational position information in any manner. For example, the torque-turns data manager may receive graphical information including an image of a torque-turns graph. In some examples, the torque-turns data manager may receive numerical information of torque associated with numerical position.

The torque-turns data manager may prepare the torque-turns dataset for processing by a deep learning model. For example, the torque-turns data manager may include a data scaling manager. The data scaling manager may scale a torque-turns dataset to a pre-determined scale or a pre-determined value. The deep learning model may be trained on a particular torque or total rotations scale. Scaling the torque-turns dataset to the pre-determined scale may help to improve the accuracy of the analysis by the deep learning model.

The torque-turns data manager may include a graph processing manager. The graph processing manager may process image-based torque-turns datasets. For example, the torque-turns data manager may receive a graphical image of a torque-turns dataset. The graph processing manager may process the graphical image based on a preferred input for the deep learning model. For example, the graph processing manager may adjust the contrast, the size, the orientation, the clarity, the color scheme, or other aspect of image-based torque-turns datasets.

In some embodiments, the graph processing manager may convert a numerical torque-turns dataset to a graphical or image-based torque-turns dataset. The deep learning model may be trained based on graphical or image-based torque-turns datasets. To improve the accuracy and/or relevance of the joint quality score by the deep learning model, the graph processing manager may convert the numerical torque-turns dataset to a graphical or an image-based torque-turns dataset.

In some embodiments, the graph processing manager may convert a graphical torque-turns dataset to a numerical torque-turns dataset. The deep learning model may be trained based on numerical torque-turns datasets. To improve the accuracy and/or relevance of the joint quality score by the deep learning model, the graph processing manager may convert the graphical torque-turns dataset to a numerical torque-turns dataset.

The torque-turns data manager may include a training dataset manager. The training dataset manager may generate a training dataset to train the deep learning model. For example, the training dataset manager may obtain a plurality of torque-turns datasets from the sensors. The training dataset manager may receive, such as from a trained operator, joint quality scores for each of the torque-turns datasets. The training dataset manager may separate the torque-turns datasets to a training dataset and a validation dataset. The torque-turns data manager may send the training dataset to the deep learning model to train the deep learning model.

To generate the training dataset, the elements of the torque-turns data manager may process the torque-turns datasets. For example, the training dataset manager may cause the data scaling manager to scale torque-turns datasets in the training dataset to the pre-determined scale. In some examples, the training dataset manager may instruct the graph processing manager to process the graphical images to comply with the input standards to train the deep learning model.

In accordance with at least one embodiment of the present disclosure, the graph processing manager may generate multiple torque-turns datasets from a single torque-turns dataset by adjusting image properties of the single torque-turns dataset. For example, the graph processing manager may adjust the contrast, the color, the background, the foreground, and other elements of the single torque-turns dataset. This may increase the number of torque-turns datasets included in the training dataset. As a specific example, the graph processing manager may increase the number of good joint quality scores to facilitate training the deep learning model to identify good joint quality scores.

The deep learning model may include a joint quality score generator. Training the deep learning model may include training the joint quality score generator to identify a joint quality score. In some embodiments, training the deep learning model may include training the joint quality score generator to over-represent poor joint quality scores and/or indeterminate joint quality scores. For example, during training of the deep learning model, a constraint may be placed on the deep learning model that results in over-identification of poor joint quality scores and/or indeterminate joint quality scores. Over-identification of poor and/or indeterminate joint quality scores may help to prevent or reduce the installation of casings having poor joint connections.

The casing connection management system may further include a casing installation manager. As discussed herein, the casing installation manager may receive the joint quality score from the deep learning model. Based on the joint quality score, the casing installation manager may continue to install additional casing segments or may cause the casing segment having the poor joint quality score to be removed.

A deep learning model training system may train a deep learning model to generate joint quality scores. As may be understood, the deep learning model training system may train any type of deep learning model. The type of deep learning model trained by the deep learning model training system may be any type of deep learning model. In some embodiments, the deep learning model trained by the deep learning model training system is based on the format or type of received torque-turns datasets. For example, graphical torque-turns datasets may be used to train a convoluted neural network. In some examples, numerical torque-turns datasets may be used to train a deep belief network or other deep learning model. However, it should be understood that any type of deep learning model may be trained with any type of input torque-turns datasets.

To train the deep learning model, a plurality of torque-turns datasets may be split into a training dataset and a validation dataset. The training dataset may be input to a deep learning model to train the deep learning model. As discussed herein, the training dataset may be processed prior to training the deep learning model. For example, the torque-turns datasets may be scaled to a pre-determined scale. In some examples, images of the torque-turns datasets may be modified to increase the size of the training dataset, such as by changing contrast, background colors, foreground colors, and so forth.

Each of the torque-turns datasets may be associated with a particular connection type. Connection types may vary between manufacturers, and may have different joint connection shapes, profiles, torque limits, rotation limits, and so forth. In some embodiments, a different deep learning model may is trained based on received torque-turns datasets for a particular connection type. This may help to ensure that the deep learning model identifies joint quality scores for the desired connection type, thereby improving the accuracy of the resulting joint quality scores.

In accordance with at least one embodiment of the present disclosure, the deep learning model may not have as inputs or constraints any parameters used to determine the joint quality score. For example, the deep learning model may not have as constraints any of the specified torque limits (e.g., minimum torque, maximum torque, desired torque), the specified rotation limits (e.g., minimum number of rotations, maximum number of rotations, desired number of rotations), a specified shape (including slopes, average values, torque values at particular rotational positions), any other input or constraint, and combinations thereof.

Each of the received torque-turns datasets may include an associated joint quality score. When the deep learning model obtains the received torque-turns datasets, the deep learning model may analyze a torque-turns dataset to generate an output quality score.

The deep learning model training system may include a quality score check. The quality score check may check the quality score of the analyzed torque-turns dataset. Based on the quality score check, the deep learning model may be re-trained. For example, if the quality score check indicates that the output quality score is not the same as the input output quality score, the deep learning model may be re-trained, adjusting the weight of one or more nodes comprising the deep learning model.

The deep learning model may be validated using the validation dataset. Validating the deep learning model may include inputting the torque-turns datasets from the validation dataset without the joint quality score. The deep learning model may generate a joint quality score for the torque-turns datasets in the validation dataset. The output quality score may be checked by the quality score check to the joint quality score from the validation dataset.

As discussed herein, the deep learning model may be trained to over-emphasize poor joint quality scores and/or indeterminate joint quality scores. For example, during validation, the deep learning model may be re-trained if a torque-turns dataset receives a good joint quality score, but the validated joint-quality score is poor. In some embodiments, the deep learning model may be validated if none of the identified output quality scores are identified as good when they should be identified as poor. The deep learning model may still be validated if one or more output quality score are identified as a poor or indetermined joint quality score when they should be identified as good. As discussed herein, this conservative identification of the joint quality score may facilitate a reduction or elimination of the installation of joints having a poor quality.

When the deep learning model has been validated, a new torque-turns dataset may be input to the deep learning model. The deep learning model may generate an output quality score based on the new torque-turns dataset. As discussed herein, a casing installation manager may make casing installation decisions based on the output quality score. For example, the casing installation manager may determine whether to re-do the casing connection, remove the casing connection, or approve the casing connection based on the output quality score. In some embodiments, the casing installation manager provides the new torque-turns dataset to an operator based on the output quality score.

The techniques described herein may be described as a number of different methods, systems, devices, and computer-readable media of the casing connection management system. In addition to the foregoing, one or more embodiments may also be described in terms of methods comprising acts for accomplishing a particular result. The methods may be performed with more or fewer acts. Further, the acts may be performed in differing orders. Additionally, the acts described herein may be repeated or performed in parallel with one another or parallel with different instances of the same or similar acts.

A casing installation manager may obtain a training dataset including a plurality of torque-turns datasets for a plurality of casing joint connections. Each of the plurality of torque-turns datasets may include a joint quality score for an associated casing joint connection of the plurality of casing joint connections. For example, the training dataset may include torque-turns datasets for historical wellbores. The wellbores may include casing joint connections having the same connection type or connection properties.

The casing installation manager may train, using the training dataset, a deep learning model to generate a new joint quality score for a new torque-turns dataset. The new torque-turns dataset may be a torque-turns dataset from a casing joint connecting being installed in an active wellbore. Generating the new joint quality score may facilitate the casing installation manager to determine whether the casing joint connection quality is good or poor in real-time, or before the casing is installed and/or grouted in the wellbore.

In some embodiments, as discussed herein, training the deep learning model may include training the deep learning model based on a constraint to over-generate a poor joint quality score. This may facilitate reducing or preventing installation of casings having poor joint casing joint connections.

In some embodiments, obtaining the training dataset includes receiving the plurality of torque-turns datasets and processing the plurality of torque-turns datasets. Processing the torque-turns datasets may include scaling the plurality of torque-turns datasets to a pre-determined scale.

In some embodiments, as discussed herein, obtaining the training dataset includes obtaining the training dataset for a casing connection type. Training the deep learning model may include training the deep model for the casing connection type.

In some embodiments, inputting the new torque-turns dataset to the deep learning model to generate the new joint quality score. The new joint quality score may be associated with the new torque-turns dataset.

In some embodiments, when the new joint quality score is above a threshold (e.g., a good joint quality score), the casing installation manager may install a casing segment associated with the new torque-turns dataset in a wellbore. When the new joint quality score is below a threshold (e.g., a poor joint quality score), the casing installation manager may disconnect the casing segment associated with the new torque-turns dataset.

In some embodiments, as discussed herein, the plurality of torque-turns datasets include a plurality of graphs illustrating torque with respect to number of rotations. In some embodiments, the plurality of torque-turns datasets each include a plurality of torque measurements at a plurality of rotational positions. In some embodiments, the deep learning model includes a convoluted neural network.

A casing installation manager may obtain a torque-turns dataset. The torque-turns dataset may include a plurality of rotation-series torque measurements. The rotation-series torque measurements may include torque measurements measured at a particular rotational position. For example, rotation-series torque measurements may include torque measurements paired with rotational position measurements. In some examples, rotation-series torque measurements may include torque measurements measured at certain rotational positions. In some examples, the rotation-series torque measurements may include any measurement scheme between torque measurements and rotation measurements.

The casing installation manager may receive, based on the torque turns dataset, including the rotation-series measurements, and based on a pre-determined standard, a joint quality score. The casing installation manager may scale the torque-turns dataset, including the rotation-series measurements, to a pre-determined scale based on the pre-determined standard. The casing installation manager may train, using the scaled torque-turns dataset, a deep learning model to generate a new joint quality score for a new torque-turns dataset.

As discussed herein, training the deep learning model may include training the deep learning model based on a constraint to over-generate a poor-joint quality score.

One or more computer systems may be used to implement the various devices, components, and systems described herein.

The computer system includes a processor. The processor may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor may be referred to as a central processing unit (CPU). Although just a single processor is described, in an alternative configuration, a combination of processors (e.g., an ARM and DSP) could be used.

The computer system also includes memory in electronic communication with the processor. The memory may be any electronic component capable of storing electronic information. For example, the memory may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions and data may be stored in the memory. The instructions may be executable by the processor to implement some or all of the functionality disclosed herein. Executing the instructions may involve the use of the data that is stored in the memory. Any of the various examples of modules and components described herein may be implemented, partially or wholly, as instructions stored in memory and executed by the processor. Any of the various examples of data described herein may be among the data that is stored in memory and used during execution of the instructions by the processor.

A computer system may also include one or more communication interfaces for communicating with other electronic devices. The communication interface(s) may be based on wired communication technology, wireless communication technology, or both. Some examples of communication interfaces include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system may also include one or more input devices and one or more output devices. Some examples of input devices include a keyboard, mouse, microphone, remote control device, button, joystick, trackball, touchpad, and lightpen. Some examples of output devices include a speaker and a printer. One specific type of output device that is typically included in a computer system is a display device. Display devices used with embodiments disclosed herein may utilize any suitable image projection technology, such as liquid crystal display (LCD), light-emitting diode (LED), gas plasma, electroluminescence, or the like. A display controller may also be provided, for converting data stored in the memory into text, graphics, and/or moving images (as appropriate) shown on the display device.

The various components of the computer system may be coupled together by one or more buses, which may include a power bus, a control signal bus, a status signal bus, a data bus, etc. For the sake of clarity, the various buses described as a bus system.

The following description includes various embodiments that, where feasible, may be combined in any permutation. For example, the embodiment of ¶ [0171] may be combined with any or all embodiments of the following paragraphs. Embodiments that describe acts of a method may be combined with embodiments that describe, for example, systems and/or devices. Any permutation of the following paragraphs is considered to be hereby disclosed for the purposes of providing “unambiguously derivable support” for any claim amendment based on the following paragraphs. Furthermore, the following paragraphs provide support such that any combination of the following paragraphs would not create an “intermediate generalization.”

In some embodiments, a method for classifying casing joint connections for casing in a wellbore, the method comprises:
obtaining a training dataset including a plurality of torque-turns datasets for a plurality of casing joint connections, each of the plurality of torque-turns datasets including a joint quality score for an associated casing joint connection of the plurality of casing joint connections; and
training, using the training dataset, a deep learning model to generate a new joint quality score for a new torque-turns dataset.

In some embodiments, the method includes wherein training the deep learning model includes training the deep learning model based on a constraint to over-generate a poor joint quality score.

In some embodiments, the method includes wherein obtaining the training dataset includes receiving the plurality of torque-turns datasets and processing the plurality of torque-turns datasets.

In some embodiments, the method includes wherein processing the plurality of torque-turns datasets includes scaling the plurality of torque-turns datasets to a pre-determined scale.

In some embodiments, the method includes wherein obtaining the training dataset includes obtaining the training dataset for a casing connection type and wherein training the deep learning model includes training the deep learning model for the casing connection type.

In some embodiments, the method includes inputting the new torque-turns dataset to the deep learning model to generate the new joint quality score.

In some embodiments, the method includes when the new joint quality score is above a threshold, installing a casing segment associated with the new torque-turns dataset in a wellbore.

In some embodiments, the method includes when the new joint quality score is below a threshold, disconnecting a casing segment associated with the new torque-turns dataset.

In some embodiments, the method includes wherein the plurality of torque-turns datasets include a plurality of graphs illustrating torque with respect to number of rotations.

In some embodiments, the method includes wherein the plurality of torque-turns datasets each include a plurality of torque measurements at a plurality of rotational positions.

In some embodiments, the method includes wherein the deep learning model includes a convoluted neural network.

In some embodiments, a method for classifying casing joint connections for casing in a wellbore, the method comprises:
obtaining a torque-turns dataset, the torque-turns dataset including a plurality of rotation-series torque measurements for a casing joint connection;
receiving, based on a pre-determined standard for the casing joint connection, a joint quality score;
scaling the torque-turns dataset to a pre-determined scale based on the pre-determined standard; and
training, using the torque-turns dataset scaled to the pre-determined scale, a deep learning model to generate a new joint quality score for a new torque-turns dataset.

In some embodiments, the method includes wherein training the deep learning model includes training the deep learning model based on a constraint to over-generate a poor joint quality score.

In some embodiments, the method includes wherein training the deep learning model includes not identifying, to the deep learning model, any parameters used to determine the joint quality score.

In some embodiments, the method includes wherein receiving the torque-turns dataset includes receiving a graph of the torque-turns dataset.

In some embodiments, the method includes inputting the new torque-turns dataset to the deep learning model to generate the new joint quality score.

In some embodiments, the method includes when the new joint quality score is above a threshold, installing a casing segment associated with the new torque-turns dataset in a wellbore.

In some embodiments, a casing installation manager, comprises:
a torque sensor;
a rotation sensor; and
a processor and memory, the memory including instructions that causes the processor to:
   obtain a training dataset including a plurality of torque-turns datasets for a plurality of casing joint connections, each of the plurality of torque-turns datasets including a joint quality score for an associated casing joint connection of the plurality of casing joint connections; and
   train, using the training dataset, a deep learning model to generate a new joint quality score for a new torque-turns dataset.

In some embodiments, the casing installation manager includes wherein training the deep learning model includes training the deep learning model based on a constraint to over-generate a poor joint quality score.

In some embodiments, the casing installation manager includes wherein obtaining the training dataset includes receiving the plurality of torque-turns datasets and scaling the plurality of torque-turns datasets to a pre-determined scale.

The embodiments of casing installation manager have been primarily described with reference to wellbore drilling operations; the casing installation manager described herein may be used in applications other than the drilling of a wellbore. In other embodiments, casing installation managers according to the present disclosure may be used outside a wellbore or other downhole environment used for the exploration or production of natural resources. For instance, casing installation managers of the present disclosure may be used in a borehole used for placement of utility lines. Accordingly, the terms “wellbore,” “borehole” and the like should not be interpreted to limit tools, systems, assemblies, or methods of the present disclosure to any particular industry, field, or environment.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for classifying casing joint connections for casing in a wellbore, the method comprising:
obtaining a training dataset including a plurality of torque-turns datasets for a plurality of casing joint connections, each of the plurality of torque-turns datasets including a joint quality score for an associated casing joint connection of the plurality of casing joint connections; and
training, using the training dataset, a deep learning model to generate a new joint quality score for a new torque-turns dataset.

2. The method of claim 1, wherein training the deep learning model includes training the deep learning model based on a constraint to over-generate a poor joint quality score.

3. The method of claim 1, wherein obtaining the training dataset includes receiving the plurality of torque-turns datasets and processing the plurality of torque-turns datasets.

4. The method of claim 3, wherein processing the plurality of torque-turns datasets includes scaling the plurality of torque-turns datasets to a pre-determined scale.

5. The method of claim 1, wherein obtaining the training dataset includes obtaining the training dataset for a casing connection type and wherein training the deep learning model includes training the deep learning model for the casing connection type.

6. The method of claim 1, further comprising inputting the new torque-turns dataset to the deep learning model to generate the new joint quality score, wherein the new joint quality score facilitates a casing installation manager to determine a casing joint connection quality.

7. The method of claim 6, further comprising, when the new joint quality score is above a threshold, installing a casing segment associated with the new torque-turns dataset in a wellbore.

8. The method of claim 6, further comprising, when the new joint quality score is below a threshold, disconnecting a casing segment associated with the new torque-turns dataset.

9. The method of claim 1, wherein the plurality of torque-turns datasets include a plurality of graphs illustrating torque with respect to number of rotations.

10. The method of claim 1, wherein the plurality of torque-turns datasets each include a plurality of torque measurements at a plurality of rotational positions.

11. The method of claim 1, wherein the deep learning model includes a convoluted neural network.

12. A method for classifying casing joint connections for casing in a wellbore, the method comprising:
obtaining a torque-turns dataset, the torque-turns dataset including a plurality of rotation-series torque measurements for a casing joint connection;
receiving, based on a pre-determined standard for the casing joint connection, a joint quality score;
scaling the torque-turns dataset to a pre-determined scale based on the pre-determined standard; and
training, using the torque-turns dataset scaled to the pre-determined scale, a deep learning model to generate a new joint quality score for a new torque-turns dataset.

13. The method of claim 12, wherein training the deep learning model includes training the deep learning model based on a constraint to over-generate a poor joint quality score.

14. The method of claim 12, wherein training the deep learning model includes the deep learning model identifying parameters used to determine the joint quality score.

15. The method of claim 12, wherein receiving the torque-turns dataset includes receiving a graph of the torque-turns dataset.

16. The method of claim 12, further comprising inputting the new torque-turns dataset to the deep learning model to generate the new joint quality score, wherein the new joint quality score facilitates a casing installation manager to determine a casing joint connection quality.

17. The method of claim 16, further comprising, when the new joint quality score is above a threshold, installing a casing segment associated with the new torque-turns dataset in a wellbore.

18. A casing installation manager, comprising:
a torque sensor;
a rotation sensor; and
a processor and memory, the memory including instructions that causes the processor to:
obtain a training dataset including a plurality of torque-turns datasets for a plurality of casing joint connections, each of the plurality of torque-turns datasets including a joint quality score for an associated casing joint connection of the plurality of casing joint connections; and
train, using the training dataset, a deep learning model to generate a new joint quality score for a new torque-turns dataset.

19. The casing installation manager of claim 18, wherein training the deep learning model includes training the deep learning model based on a constraint to over-generate a poor joint quality score.

20. The casing installation manager of claim 18, wherein obtaining the training dataset includes receiving the plurality of torque-turns datasets and scaling the plurality of torque-turns datasets to a pre-determined scale.
